(19) United States
(12) Patent Application Publication
(10) Pub. No.: US 2026/0344583 A1
(43) Pub. Date: Nov. 5, 2026

(54) A SYSTEM FOR ENABLING ARTIFICIAL CULTIVATION OF AZOLLA AND A METHOD THEREOF

(71) Applicants: Awstika DAS, Kolkata (IN); Souryadeep BASAK, Kolkata (IN)

(72) Inventor: Souryadeep Basak, Kolkata (IN)

(21) Appl. No.: 19/484,935

(22) PCT Filed: May 18, 2024
(86) PCT No.: PCT/IN2024/050585

§ 371 Date: Nov. 17, 2025

(30) Foreign Application Priority Data
May 19, 2023 (IN) 202331018679

(51) Int. Cl. A01G 9/24; A01G 22/15; A01G 31/00; A01G 31/06

(52) U.S. Cl. CPC A01G 9/247; A01G 9/246; A01G 22/15; A01G 31/011; A01G 31/06

(57) ABSTRACT

The present disclosure relates to a system for enabling artificial cultivation of azolla for enhancing sequestration of environmental CO₂ The system comprises a multi-level meta-structure, a set of carbon capture tanks, a set of vertical overflow pipes, a set of horizontal overflow pipes, a façade material. Each level of the meta-structure is configured to accommodate a pair of CCTs. The system further comprises an electrical pump for maintaining laminar water flow in each CCT, nozzle-based sprinklers installed over CCTs. The system also includes temperature and humidity sensors for sensing ambient temperature and humidity of the meta-structure, water temperature sensors for sensing temperature of water flowing through the CCTs. Furthermore, the system comprises pH sensors for determining pH of the liquid medium, a set of aerators to provide regular mixing of growth medium, a real time clock, a set of fans for regulating meta-structure temperature and humidity, a controlling unit, and a power source.

### TECHNICAL FIELD

The present invention is related, generally to cultivation of Azolla and more particularly, but not exclusively to a system for enabling artificial cultivation of azolla for enhancing sequestration of environmental CO₂ and a method for artificially improving growth of azolla.

### BACKGROUND

Greenhouse gases are gases that trap heat in the Earth's atmosphere, leading to global warming and climate change. Carbon dioxide (CO₂), methane (CH₄), nitrous oxide (N₂O), and fluorinated gases are the primary greenhouse gases. Natural as well as human-made emissions of greenhouse gases include burning fossil fuels for electricity, forests, farming, and industrial processes. Since the Industrial Revolution, there has been an increase in the amount of greenhouse gases in the atmosphere, mainly as a result of the burning of fossil fuels, which is rapidly changing the Earth's temperature and weather trends. The impacts of greenhouse gas emissions are far-reaching and severe, including rising sea levels, more frequent and severe weather events, changes in ecosystems and biodiversity, and economic and social disruption. Further, carbon dioxide (CO₂) accounts for about 80% of the greenhouse gases which in turn is having major impact on the environment. Some of the main impacts of increasing CO₂ levels in the environment include, but are not limited to, climate change, ocean acidification, changes in vegetation, impacts on human health, economic impacts etc. Therefore, addressing the issue of increasing CO₂ level in the environment is crucial for the sustainability of our planet.

To address the aforementioned problem, many countries and organizations are taking steps to reduce greenhouse gas emissions. That is being done through a variety of measures, such as increasing the use of renewable energy sources, improving energy efficiency, promoting sustainable agriculture practices, and implementing policies and regulations to limit emissions from industry and transportation. However, most of the technologies and research are aiming to control the emissions of CO₂ and other greenhouse gases into the environment. Such technologies and researches are devoid of sharing any insight on the capture of existing CO₂ from the environment in order to make the historical environmental emissions net zero i.e., completely negating the cumulative amount of greenhouse gases produced by anthropogenic activity. Further, there are technologies around carbon capture, that aim to reduce carbon dioxide (CO₂) emissions from industrial processes, power generation, and other sources by capturing and storing the CO₂ before it is released into the atmosphere. The process of carbon capture involves capturing CO₂ from the emissions of power plants and industrial facilities, typically using chemical solvents or adsorbents. The captured CO₂ is then transported via pipelines or trucks to a storage site, such as deep underground geological formations, depleted oil and gas reservoirs, or saline aquifers, where it is stored permanently. However, existing techniques and proposals are very expensive in nature and also require infrastructure overhead in order to achieve the objective of increased carbon sequestration.

There are a slew of options in point source carbon capture and storage, where the CO₂ is captured at the point of emission and stored in a stable form. Pre-combustion, post-combustion and oxy-fuel combustion represent the three main routes for point source carbon capture. Amine scrubbing, adsorption by metal organic frameworks, micro-algae bio-fixation, carbonaceous adsorption and membrane separation are the major techniques involved in carbon capture from flue gas streams. The captured carbon is then recovered, processed and transported into underground geological formations, such as saline aquifers and sedimentary basins, for long-term storage. The captured CO₂ may also be used for enhanced oil recovery to offset the costs associated with carbon capture and storage.

While the post-combustion technologies are relatively mature, they have dominant disadvantages of high capital cost and significant energy footprint. However, even if these challenges are subsequently overcome, such processes can at best help us transition to a net-zero future. However, the IPCC has estimated that 5-10 GtCO₂-eq has to be removed from the atmosphere each year by the middle of the century. To facilitate this scale of atmospheric CO₂ capture, non-point source carbon capture technologies have to be scaled up and decoupled from combustion processes, in contrast to point-source technologies, where the combustion process and the carbon capture process are coupled.

Furthermore, initiatives on growing more plants are instigated to defend the rapid increase of CO₂ in environment. However, such initiatives also require significant monetary cost and are limited in terms of providing increased harvesting of such plants in order to achieve the objective of capturing the carbon from the environment in maximum extent. Therefore, there is a need for more efficient methods for providing suitable conditions for enhancing cultivation of such plants so as to increase carbon sequestration from the environment.

### SUMMARY

One or more shortcomings of the prior art are overcome, and additional advantages are provided through the present disclosure. Additional features and advantages are realized through the techniques of the present disclosure. Other embodiments and aspects of the disclosure are described in detail herein and are considered a part of the claimed disclosure.

The present invention is directed to a system for enabling artificial cultivation of azolla for enhancing sequestration of environmental CO₂. The system comprises a meta-structure, a set of carbon capture tanks, a set of vertical overflow pipes, a set of horizontal overflow pipes, a façade material. The meta-structure has at least two or more levels, wherein the structural material for the meta-structure is bamboo and the two or more levels are equidistantly placed across the height of the meta-structure. Each level of the meta-structure is configured to accommodate a pair of CCTs. The façade material is used to cover a fractional part of the meta-structure. The system further comprises an electrical pump for maintaining laminar water flow in each CCT via the overflow pipes, a set of nozzle-based sprinklers installed over CCTs for maintaining humidity requirement of azolla. The system also includes a set of temperature and humidity sensors for sensing ambient temperature and humidity of the meta-structure, a set of water temperature sensors for sensing the temperature of water flowing through the CCTs. Furthermore, the system comprises a set of pH sensors for determining pH of the liquid medium, a set of aerators to provide regular mixing of the growth medium, a real time clock, a set of fans for regulating meta-structure temperature and humidity, a controlling unit, and a power source. The controlling unit is capable of modulating the electrical pump, the aerators, the sprinklers, and the fans, wherein the controlling unit is communicably coupled with the temperature and humidity sensors, the water temperature sensors, the pH sensors, and the real time clock. The power source supplies power to the electrical pump, the aerators, the sprinklers, the temperature and humidity sensors, the water temperature sensors, the pH sensors, the real time clock, the fans and the controlling unit. In one embodiment, the controlling unit is configured to automatically control operations of the pump, the aerators, the sprinklers, and the fans based on received input from the temperature and humidity sensors, the water temperature sensors, the pH sensors, and the real time clock so as to maintain desired micro-climate for growth of azolla.

In another embodiment, the present disclosure relates to a method for artificially improving growth of azolla in a meta-structure for enhancing sequestration of environmental CO₂. The method comprises the steps of setting up a meta-structure comprising at least two or more levels, a set of carbon capture tanks (CCT), a set of vertical overflow pipes and a set of horizontal overflow pipes wherein structural material for the meta structure is bamboo, and each level of the meta-structure is configured to accommodate a pair of CCTs. The method includes maintaining a water level till a predefined height within each CCT, laminar flow of water within each CCT via the overflow pipes by using an electrical pump, a predefined range of pH and Total Dissolved Solids (TDS) of the water in order to provide a suitable growth medium for azolla. The method further comprises preparing a fertilizer for the growth medium from ripe banana peels that is an organic biodegradable waste containing negligible amount of nitrogen, and removing sediment load including soil and biomass components at periodic intervals in order to maintain optimal nitrogen levels in the growth medium. The method also includes adding fertile soil that is acidic in nature to each CCT at a rate of 1-1.5 kg/m2 for providing micro-nutrients to azolla, and upon preparing the growth medium in each CCT, introducing azolla inoculum in each CCT covering at least 75% of CCT area. The method also includes maintaining flow of water within each CCT for preserving desired pH of the growth medium, and humidity of the meta-structure via a set of sprinklers for a predefined acclimatization period; manually agitating azolla fronds after the acclimatization period to aid in additional growth of azolla; and harvesting azolla at a pre-defined frequency and intensity.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1A illustrates an architectural diagram of a system for artificial cultivation of azolla, in accordance with some embodiments of the present disclosure;

FIG. 1B-1D illustrate schematic diagrams of a meta-structure for artificial cultivation of azolla, in accordance with some embodiments of the present disclosure;

FIG. 2 illustrates a method for artificially improving growth of azolla in a meta-structure, in accordance with some embodiments of the present disclosure; and

FIG. 3A-3C illustrate workflows for different operations of the controlling unit, in accordance with some embodiments of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternatives falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus preceded by “comprises . . . a” does not, without more constraints, preclude the existence of other elements or additional elements in the system or method.

Embodiment of the present disclosure relates to a system for enabling artificial cultivation of azolla for enhancing sequestration of environmental CO₂. The system comprises a meta-structure, a set of carbon capture tanks, a set of vertical overflow pipes, a set of horizontal overflow pipes, and a façade material. The meta-structure has at least two or more levels, wherein the structural material for the meta-structure is bamboo and the two or more levels are equidistantly placed across height of the meta-structure. Each level of the meta-structure is configured to accommodate a pair of CCTs. The façade material is used to cover a fractional part of the meta-structure. The system further comprises an electrical pump for maintaining laminar water flow in each CCT via the overflow pipes, a set of nozzle-based sprinklers installed over CCTs for maintaining humidity requirement of azolla. The system also includes a set of temperature and humidity sensors for sensing ambient temperature and humidity of the meta-structure, a set of water temperature sensors for sensing the temperature of water flowing through the CCTs. Furthermore, the system comprises a set of pH sensors for determining the pH of the liquid medium, a set of aerators to provide regular mixing of the growth medium, a real time clock, a set of fans for regulating meta-structure temperature and humidity, a controlling unit, and a power source. The controlling unit is capable of modulating the electrical pump, the aerators, the sprinklers, and the fans, wherein the controlling unit is communicably coupled with the temperature and humidity sensors, the water temperature sensors, the pH sensors, the real time clock. The power source supplies power to the electrical pump, the aerators, the sprinklers, the temperature and humidity sensors, the water temperature sensors, the pH sensors, the real time clock, the fans and the controlling unit.

In one embodiment, the controlling unit is configured to automatically control operations of the pump, the aerators, the sprinklers, and the fans based on received input from the temperature and humidity sensors, the water temperature sensors, the pH sensors, and the real time clock so as to maintain desired micro-climate for growth of azolla. In another embodiment, the controlling unit is configured to determine current season of the location of the meta-structure based on accurate local time as received from the real time clock, and set seasonal functioning timings of the pump, the aerators, the sprinklers, and the fans. Additionally, the controlling unit determines time of day based on the input from the real time clock and temperature differential between water and air for compensating the micro-climate of the azolla.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Azolla is an aquatic fern with very high growth rates, achieving a biomass doubling time of 2 to 5 days under optimal conditions. Apart from the high growth rates, azolla has a symbiotic relationship with an endophytic cyanobacteria Anabaena azollae which can fix atmospheric nitrogen. This characteristic enables the growth of azolla in nitrogen deficient conditions. Azolla can be used as a nutritional supplement for fish, poultry and dairy livestock. Azolla based biofuels are another end use alternative through the process of transesterification. Since both the aforementioned end uses release a portion of the captured CO₂ back to the atmosphere, the proposed invention focusses on the use of azolla as a bio-fertiliser, offsetting the demand for nitrogenous fertilizers like urea and di-ammonium phosphate, which are responsible for significant greenhouse gas emissions.

Azolla is a freshwater fern that has one of the lowest recorded biomass doubling times, doubling in about 2-5 days under optimal conditions. Azolla prefers partial shade (15-18 Klux), moderate temperatures (18-28 °C) and moderate to high relative humidity (55-83%). The azolla genus has six species which are naturally found in tropical and low-latitude temperate regions. Azolla lives in symbiosis with the nitrogen fixing cyanobacteria Anabaena azollae. The independence of the water fern in terms of nitrogen requirement allows it to propagate quickly in natural habitats when conditions are optimal. Other similar floating plants like Lemna major and Lemna minor do not possess such nitrogen independence. The harvested azolla can be most commonly used as animal feed, bio-fuel or bio-fertilizer. The proposed invention would eliminate carbon dioxide emissions and nitrous oxide emissions associated with the extensive use of nitrogenous fertilizers like urea and di-ammonium phosphate. Furthermore, the decentralized adoption of azolla bio-fertilizer would also reduce costs for small and marginal farmers, granting them a greater degree of resilience and independence.

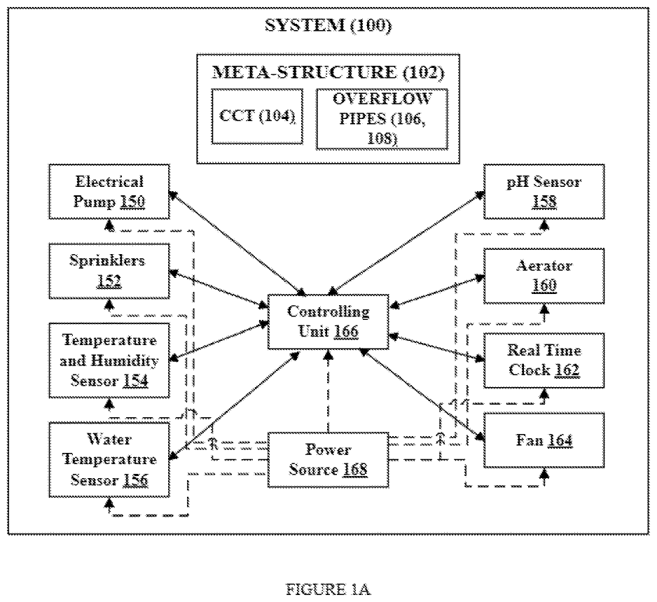

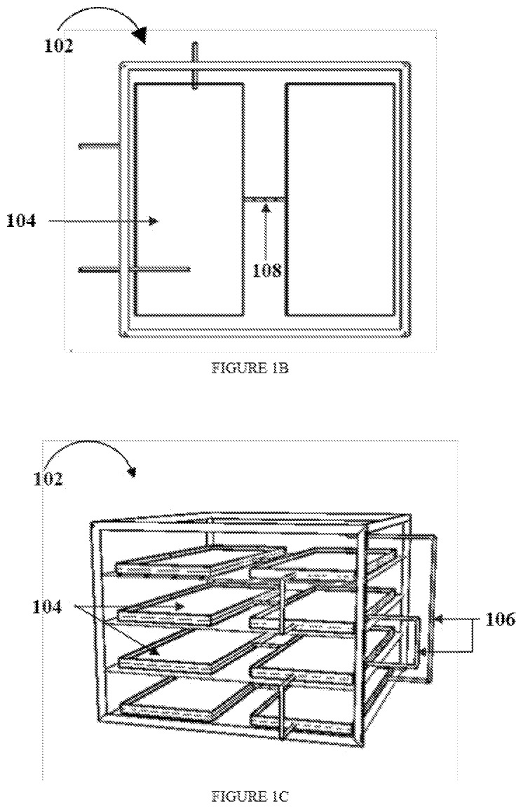

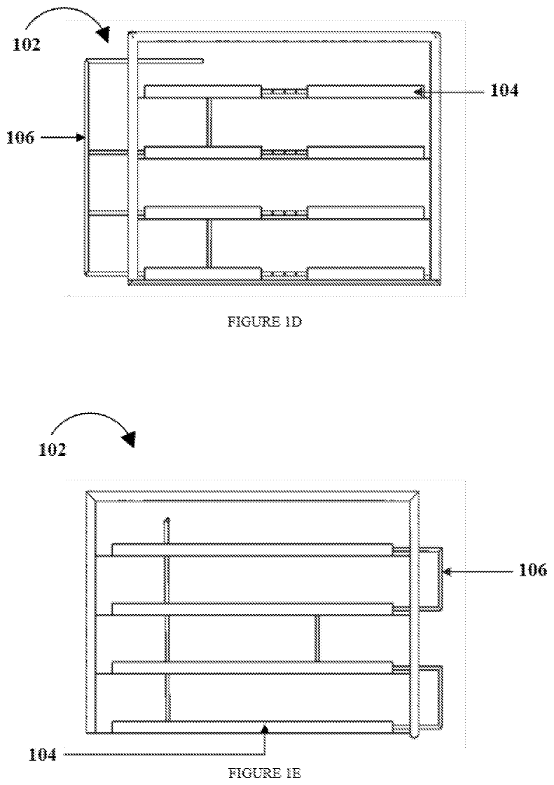

The following paragraphs describe the present disclosure with reference to FIGS. 1 to 3. In the figures, FIG. 1A illustrates a system for enabling artificial cultivation of azolla for enhancing sequestration of environmental CO₂. The system comprises a meta-structure (102), a set of carbon capture tanks (CCT) (104), a set of vertical overflow pipes (106) and a set of horizontal overflow pipes (108), and a façade material to cover a fractional part of the meta-structure (102). The system further comprises an electrical pump (150) for maintaining laminar water flow in each CCT via the overflow pipes, a set of nozzle-based sprinklers (152) installed over CCTs for maintaining humidity requirement of azolla. The system also comprises a set of temperature and humidity sensors (154) for sensing ambient temperature and humidity of the meta-structure (102), and a set of water temperature sensors (156) for sensing temperature of water flowing through the CCTs. The system includes a set of pH sensors (158) for determining pH of the liquid medium, a set of aerators (160) to provide regular mixing of growth medium, a real time clock (162), and a set of fans (164) for regulating meta-structure temperature and humidity. Additionally, the system includes a controlling unit (166) and a power source (168).

The controlling unit (166) is capable of modulating the electrical pump (150), the aerators (160), the sprinklers (152), and the fans (164), wherein the controlling unit (166) is communicably coupled with the temperature and humidity sensors (154), the water temperature sensors (156), the pH sensors (158), and the real time clock (162). The power source (168) supplies power to the electrical pump (150), the aerators (160), the sprinklers (152), the temperature and humidity sensors (154), the water temperature sensors (156), the pH sensors (158), the real time clock (162), the fans (164) and the controlling unit (166).

FIG. 1B-1E are illustrations of a meta-structure (102) for artificial cultivation of azolla for enhancing sequestration of environmental CO₂. FIG. 1B illustrates a top view of the meta-structure (102), wherein the meta-structure is configured to accommodate a pair of carbon capture tanks (CCT) (104) at the top level of the meta-structure (102). The pair of CCTs (104) is further connected by a horizontal overflow pipe (108) in order to maintain the flow of water between the CCTs.

FIG. 1C illustrates a perspective view of the meta-structure (102), wherein the meta-structure is having at least two or more levels, wherein and the two or more levels are equidistantly placed across height of the meta-structure (102). The meta-structure is configured to secure a set of vertical overflow pipes (106) across the height of the meta-structure (102) in order to connect the CCTs (104) at each level of the meta-structure (102). The structural material used for the meta structure (102) is bamboo. In one embodiment, the bamboo used for the meta-structure (102) is processed by submerging raw harvested bamboo in water and treating with boric acid, cashew oil, wood-shell oil and grounds seeds of the poganum plant (Pongamia pinnata).

FIG. 1D illustrates a front view of the meta-structure (102), wherein each level of the meta-structure (102) is configured to accommodate a pair of CCTs (104) connected by the horizontal overflow pipe (108), and the inter-level CCTs are connected by the set of vertical overflow pipes (106). FIG. 1E illustrates a right view of the meta-structure (102).

In an example, the meta-structure consists of n levels with two carbon capture tanks (CCT) on each level separated by a walkway of width 1.2-1.5 m. While there may be more than 2 CCTs on each level, such a setup can be thought of as multiple aggregated unit meta-structures. The orientation of each the CCTs is transverse to the orientation of the meta-structure, the longer edge of the meta-structure corresponds to the shorter edge of the CCTs. The standard dimensions of each CCT are 5 m (1)×2 m (w)×0.5 m (h). Therefore, the standard dimensions of the meta-structure are 6.2 m (L)×6 m (W)×H (function of latitude).

Each CCT is fabricated using chlorinated polyvinylchloride (cPVC) to ensure structural longevity on continued exposure to attenuated solar radiation, and coated with black color so as to minimize the amount of radiation absorbed and consequently transmitted within the growth medium.

The inter-level spacing of the two or more equidistantly placed levels is determined based on breadth of the meta-structure (102) and maximum value of zenith angle of the Sun in particular latitude of location of the meta-structure (102). The zenith angle (02) is defined as the angle between the sun and the normal to the local surface. The declination angle (δ) is defined as the angle between the solar vector and the equatorial plane. The hour angle (ω) is defined as the angle between the solar vector and the projection of the local zenith vector on the equatorial plane. Assuming the geographical north-south axis to be the z-axis and the local zenith vector to be the x-axis, the local zenith angle can be expressed as a function of latitude, declination angle and hour angle as follows:

θ_{z}=cos⁻¹[cos Ø cos δ cos ω+sin Ø sin δ]

Therefore, the meta-structure inter-level spacing can be expressed in terms of the meta-structure breadth (W) and the maximum value of zenith angle (for locations beyond the tropics in the northern hemisphere) as an inequality:

H≥W tan θzₘₐₓ

In the limiting condition, the inter-level spacing is calculated by the following formula:

H=W tan θzₘₐₓ

For locations within the tropics, the same equality holds for meta-structure design principles.

The height of each CCT is constant due to this parameter being a function of the natural process of bio-sequestration through growth of Azolla pinnata. The water level is maintained at a range of 0.15-0.20 meter in each CCT for optimal growth of Azolla pinnata.

In another embodiment, meta-structure coverage area of the façade material (not shown in figure) is determined based on the latitude of the location of the meta-structure (102) and the time of the year so as to maintain an optimal micro-climate for azolla growth upon reducing evaporative losses and preventing direct exposure to incident solar radiation. For the northern hemisphere, the meta-structure (102) is covered on the south, east and west sides using 70% shade nets as the façade material. For the southern hemisphere, the façade is provided on the north, east and west sides. However, if the latitude of the location lies between the tropics, façade arrangements may also be provided on the remaining fourth side. The façade percentage on all sides can be manually adjusted to account for variations in incident radiation, cloud cover and dry bulb temperature.

The façade material coverage of the meta-structure is critical to the maintenance of a year-round optimal crop of azolla. During the summer months, the shading by the façade material prevents the production of anthocyanin within azolla fronds, which is an indicator of plant stress and eventually leads to retarded biomass growth rates. During the monsoons season, the primary purpose of the façade material is to prevent the ingress of pests and inoculation by parasitic organisms. The façade material coverage modulation is most critical during the winter months, wherein reduced overage area during the day allows diffuse solar radiation to elevate water temperatures to optimal values, while complete coverage of the meta-structure at night prevents the deposition of fog, which might lead to mass death of the azolla culture. In surmise, the façade material is critical for a continuous crop of azolla, foregoing the exercise of mass death and subsequent re-inoculation of each CCT, maximizing the cumulative annual azolla harvest that can be derived from a single meta-structure. In an example, the façade material coverage of the meta-structure is determined to be 50% during TZ1, 90% during TZ2, 100% during TZ3 and TZ4 respectively, where TZ1, TZ2, TZ3, and TZ4 are different time zones in a day, wherein TZ1 indicates 0500 hrs-0900 hrs, TZ2 indicates 0900 hrs-1500 hrs, TZ3 indicates 1500 hrs-2000 hrs, and TZ4 indicates 2000 hrs-0500 hrs.

Further, laminar water flow is essential for optimal growth of the azolla fern as well as for deterring the incubation of mosquito larvae, among other pests. Furthermore, regular water flow suppresses algal growth and thermal stratification in the growth medium of each CCT.

The electrical pump (150) is appropriately selected based on size of the meta-structure (102) to adequately regulate the water flow. The electrical pump (150) for water regulation is a device used to control and adjust the flow rate of water within a system using electrical power. These pumps are designed to regulate the amount of water moving through pipes, channels, or other conduits in various applications. One of the primary features of the electrical pump (150) for water regulation is their ability to vary the speed of the pump motor. The electrical pump (150) for water regulation is integrated into the controlling unit for automated control, allowing for remote monitoring and adjustment of pump operation. Such automation enables real-time response to changes in system conditions, user-defined setpoints, or sensor inputs, improving efficiency and reliability.

In order to maintain laminar water flow, each level of the meta-structure (102) is fitted with two overflow pipes, one vertical overflow pipe (106) along the outer edge of a CCT (OF1) and one horizontal overflow pipe (108) along the inner edge of both CCTs (OF2). Both OF1 and OF2 are at a height of 0.21 m from the bottom of the CCT. OF2 connects both CCTs at each level, while OF1 transmits water from one level to the corresponding CCT on the level immediately below. The system (100) further comprises a water flow initiator (WFI) pipe that connects one of the pair of CCTs at lowermost level to corresponding CCT on the topmost level. The vertical overflow pipe of one of the CCTs at the lowermost level acts as the first part of the WFI, and a pump outlet transmits water from the lowermost CCT to the corresponding CCT on the topmost level for even number of levels. Further, in case of odd number of levels, the pump outlet transmits water from the lowermost CCT to the opposite CCT on the topmost level for even number of levels.

In an example, let us consider a 4 level meta-structure with two CCTs on each level. The nomenclature used is CCT_{xy}, where ‘x’ represents the level and ‘y’ represents the concerned CCT on that level. For this example, 1<=x<=4 and y={1, 2}. If the WFI is connected to CCT11, it will transmit water to CCT41, the corresponding CCT on the topmost level. Once the water level in CCT41 rises from 0.20 m to 0.21 m, water flows from CCT41 to CCT42 via OF2. Once the water level in CCT42 reaches 0.21 m, water flows from CCT42 to CCT32 via OF1. CCT32 then transmits water to CCT31 via OF2, which in turn transmits the overflow water to CCT21 via OF1. CCT21 transmits excess water to CCT22 via OF2, which in turn transmits water to CCT12 via OF1 on the lowest level. Eventually CCT12 feeds back the water to CCT11 via OF2, completing the cycle of water transmission. Thus, the water flow sequence for a 4-level meta-structure can be concisely summarized as follows:
CCT11→CCT41→CCT42→CCT32→CCT31→CCT21→CCT22→CCT12→CCT11

The set of aerators (160) are provided at appropriate spatial intervals within each CCT to ensure regular mixing of the growth medium and prevention of buildup of ammonia (NH₃) and hydrogen sulfide (H₂S) within the growth medium. Such gases may be produced in stagnant conditions of the growth medium, leading to a rise in the pH of the medium. Therefore, it is necessary to regularly aerate the solution for the purpose of degassing as well as oxygenation of the growth medium to ensure that anoxic conditions do not prevail.

The aerators (160) are devices designed to add air to water or another liquid. They are commonly used in various applications to increase the oxygen content in water, improve water quality, and promote the health of aquatic ecosystems. The aerators (160) increase the effective surface area of water exposed to air, facilitating the exchange of gases and replenishing oxygen levels. The aerators help in improving water circulation by creating movement and turbulence in the water. This movement helps to distribute oxygen and nutrients more evenly throughout the water column, preventing stratification and stagnation. Each of the set of aerators (160) is communicably coupled with the controlling unit (166) and is powered by the power source (168).

The humidity requirements of azolla are met through the operation of the nozzle-based sprinklers (152) installed above each CCT. A nozzle-based sprinkler is a device used for distributing water in a controlled manner over a specific area, typically for irrigation purposes in gardens, lawns, agricultural fields, or landscaped areas. The nozzle-based sprinklers (152) use specialized nozzles to disperse water in a uniform pattern over the target area. The nozzle-based sprinklers (152) are designed to deliver water directly to the target area, minimizing water wastage due to runoff, evaporation, or overspray. Each of the nozzle-based sprinklers (152) is communicably coupled with the controlling unit (166) and is powered by the power source (168).

The controlling unit (166) is a compact integrated circuit designed to govern a specific operation in an embedded system. In modern terminology, the controlling unit (166) is similar to, but less sophisticated than, a system on a chip (SoC), wherein a SoC may include a microcontroller as one of its components. The controlling unit (166) contains one or more CPUs (processor cores) along with memory and programmable input/output peripherals. The memory can be in the form of ferroelectric RAM (Random Access Memory), NOR flash or OTP ROM (Read Only Memory), RAM with small capacity etc. There is plurality of controlling units that are designed for plurality of embedded applications. The controlling unit (166) is essentially simple miniature personal computers (PCs) designed to control small features of a larger component, without a complex front-end operating system (OS). The controlling unit (166) is communicably connected to the power source (168) to transmit power to each of the electrical pump (150), the aerators (160), the sprinklers (152), the temperature and humidity sensors (154), the water temperature sensors (156), the pH sensors (158), the real time clock (162), the fans (164) and control such transmission. Each of the aforementioned components is separately connected to one of the plurality of pins of the controlling unit so that the controlling unit (166) can control each of the components separately without hampering the operations of other components.

In one embodiment, the controlling unit (166) automates the operation of the pump, aerators and sprinklers. In an example, the controlling unit (166) can be a microcontroller (ATMega328p). The controlling unit (166) receives input signals from the temperature and humidity sensors (DHT-22) (154), the water temperature sensors (DS18B20) (156), the real time clock (RTC 3231) (162) and the pH sensors (158). The laminar water flow through the WFI-OF1-OF2 route, as well as schedules for sprinklers and aerators are functions of the RTC inputs. The controlling unit (166) is configured to receive operation instructions as overridden by a user over a user device based on real time pH values, temperature and humidity data, as well as the differential between air and water temperatures. The controlling unit (166) is configured to automatically control operations of the pump (150), the aerators (160), the sprinklers (152), and the fans (164) based on received input from the temperature and humidity sensors (154), the water temperature sensors (156), the pH sensors (158), and the real time clock (162) so as to maintain desired micro-climate for growth of azolla.

In another embodiment, the controlling unit (166) is configured to determine current season of the location of the meta-structure (102) based on accurate local time as received from the real time clock (162), and control seasonal functioning of the pump (150), the aerators (160), the sprinklers (152), and the fans (164) based on respective climate zone as preset by an operator. The climate zone can be any one of the climate zones across the globe, wherein the climate zones can include but not limited to hot and humid, hot and dry, temperate or composite. The controlling unit (166) is further configured to determine time of day based on the input from the real time clock (162) and temperature differential between water and air based on the input received from the temperature and humidity sensors (154), the water temperature sensors (156). The controlling unit (166) automatically increases frequency of the pump operations via WFI pipe after sunset upon determining a temperature differential in any season beyond a threshold of 3 °C-5 °C together with air temperature outside to bring the water temperature closer to a desired range.

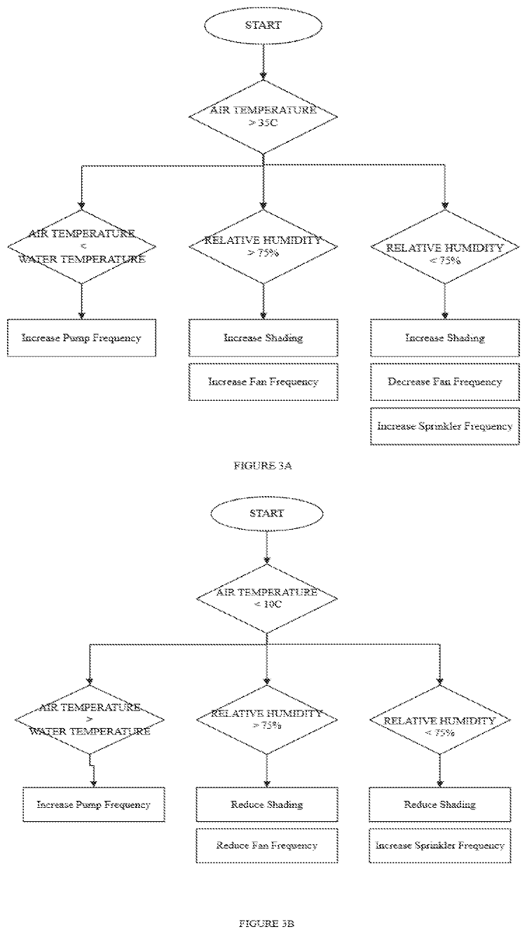

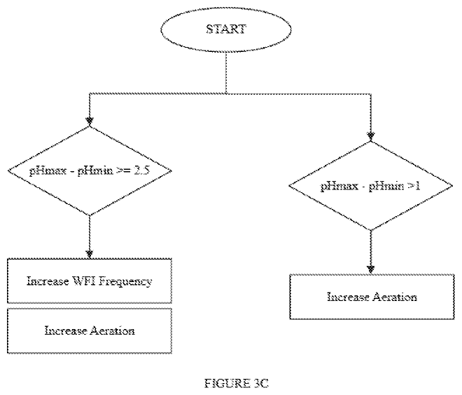

As illustrated in FIG. 3A, the controlling unit (166) is configured to automatically control the fans, the electrical pumps, the nozzle-based sprinklers. When the air temperature is determined to be greater than 35 °C and the relative humidity is greater than 75%, then the controlling unit automatically increases frequency of the fans in order to maintain the humidity in a range of 70%-75%. When the air temperature is determined to be greater than 35 °C and the relative humidity is less than 75%, then the controlling unit automatically decreases frequency of the fans and increases sprinklers' frequency in order to maintain the humidity in a range of 70%-75%. When the air temperature is determined to be greater than 35 °C and the air temperature is less than the water temperature, then the controlling unit automatically increases frequency of the electrical pump.

Further, as illustrated in FIG. 3B, the controlling unit (166) is configured to automatically control the fans, the electrical pumps, the nozzle-based sprinklers. When the air temperature is determined to be less than 10 °C and the relative humidity is greater than 75%, then the controlling unit automatically reduces frequency of the fans in order to maintain the humidity in a range of 70%-75%. When the air temperature is determined to be less than 10 °C and the relative humidity is less than 75%, then the controlling unit automatically increases sprinklers' frequency in order to maintain the humidity in a range of 70%-75%. When the air temperature is determined to be less than 10 °C and the air temperature is greater than the water temperature, then the controlling unit automatically increases frequency of the electrical pump.

Therefore, the controlling unit (166) can be configured to control the actuators including the pump (150), the aerators (160), the sprinklers (152), and the fans (164) during different time zones in a day in different climate zones, wherein a particular climate zone is preset by the operator as per the desired location of installation of the meta-structure (102). In an example, a control configuration of the controlling unit (166) for different climate zones such as hot and humid, hot and dry, temperate, composite etc. can be as illustrated in Table 1.

TABLE 1

| | Control Parameters | | | |
|---|---|---|---|---|
| Actuators | Hot & Humid | Hot & Dry | Temperate | Composite |
| Sprinklers | TZ1: 10 s/1 hr | TZ1: 25 s/1 hr | TZ1: 5 s/1 hr | TZ1: 5 s/1 hr |
| | TZ2: 15 s/1 hr | TZ2: 20 s/1 hr | TZ2: 10 s/1 hr | TZ2: 15 s/1 hr |
| | TZ3: 5 s/1 hr | TZ3: 5 s/1 hr | TZ3: 5 s/1 hr | TZ3: 5 s/1 hr |
| | TZ4: N/A | TZ4: N/A | TZ4: N/A | TZ4: N/A |
| Aerators | TZ1: N/A | TZ1: N/A | TZ1: N/A | TZ1: N/A |
| | TZ2: 15 s/0.5 hr | TZ2: 5 s/0.5 hr | TZ2: 10 s/0.5 hr | TZ2: 10 s/0.5 hr |
| | TZ3: 5 s/0.5 hr | TZ3: 5 s/1 hr | TZ3: 5 s/0.5 hr | TZ3: 5 s/0.5 hr |
| | TZ4: N/A | TZ4: N/A | TZ4: N/A | TZ4: N/A |
| WFI | TZ1: N/A | TZ1: N/A | TZ1: N/A | TZ1: N/A |
| | TZ2: 15 s/1 hr | TZ2: N/A | TZ2: 10 s/1 hr | TZ2: 15 s/1 hr |
| | TZ3: 10 s/1 hr | TZ3: 5 s/1 hr | TZ3: N/A | TZ3: 10 s/1 hr |
| | TZ4: N/A | TZ4: N/A | TZ4: N/A | TZ4: N/A |
| Fans | TZ1: N/A | TZ1: N/A | TZ1: N/A | TZ1: N/A |
| | TZ2: 45 s/1 hr | TZ2: 60 s/1 hr | TZ2: 20 s/1 hr | TZ2: 20 s/0.5 hr |
| | TZ3: 15 s/1 hr | TZ3: 30 s/1 hr | TZ3: 15 s/1 hr | TZ3: 20 s/1 hr |
| | TZ4: N/A | TZ4: N/A | TZ4: N/A | TZ4: N/A |

Where, TZ1, TZ2, TZ3, and TZ4 are different time zones in a day, wherein TZ1 indicates 0500 hrs-0900 hrs, TZ2 indicates 0900 hrs-1500 hrs, TZ3 indicates 1500 hrs-2000 hrs, and TZ4 indicates 2000 hrs-0500 hrs.
Accordingly, the controlling unit can be configured for the different time zones of other climate zones.

All electrical devices including the controlling unit, the electrical pump, the aerators, the sprinklers, the fans used in the system are direct-current (DC) devices. The controlling unit with associated sensors operates on a 5V DC bus while the actuators including the electrical pump, the aerators, the sprinklers are powered by either a 12V or 24V DC bus, depending on the specifications of the concerned actuators. To enable off-grid deployment of the meta-structure (102), the power source for the setup is an appropriately sized array of solar photovoltaic panels, installed on top of the meta-structure (102) to eliminate the need for additional land as well as provide shading on the topmost level of the meta-structure (102). The solar PV modules produce DC electrical energy as well, which is in tandem with the DC nature of the electrical apparatus employed, thereby foregoing the need for inverters. This is a significant cost reduction vis-à-vis the capital cost of electrical power system infrastructure. The output from the PV modules is fed to a maximum power point tracking (MPPT) charge controller, which relays the energy to the electrical DC loads as well as a battery of appropriate sizing for applications during non-availability of solar radiation.

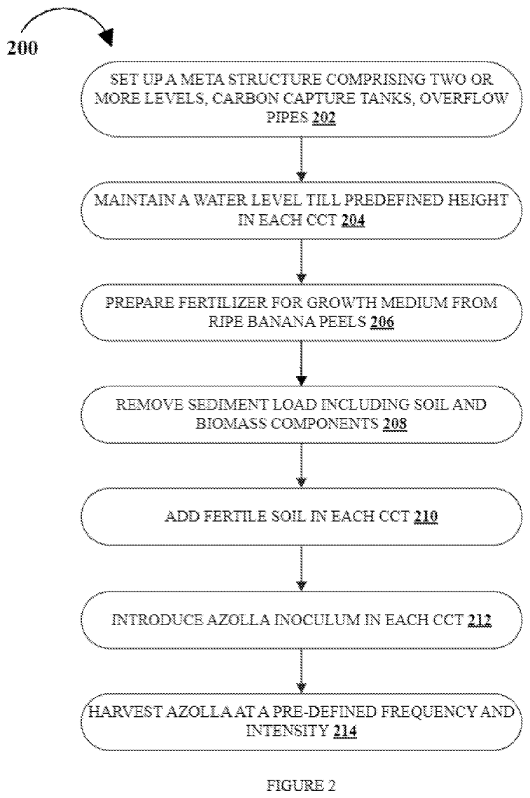

In the figures, FIG. 2 illustrates an exemplary method of the present disclosure and illustrates various steps of the method (200) for artificially improving growth of azolla in a meta-structure for enhancing sequestration of environmental CO₂. The method (200) enables to produce more azolla in meta-structure configured within a building or other construction in order to increase carbon capture from the environment by incurring very low cost and reasonable human labour. The method (100) therefore eliminates the requirement of using any kind of external power sources, additional artificial fertilizers, industry made chemicals etc. which in turn increase CO₂ while being produced in respective industries.

However, it is understood by a person skilled in the art that the size and configuration of the required set of machinery for accomplishing the method (200) may be variable in accordance with the requirement of the different types of setting up environment. Any such variation/modification shall be construed to be within the scope of the present disclosure.

As illustrated in FIG. 2, the method (200) comprises one or more blocks to be performed to provide suitable conditions for enhancing cultivation of Azolla in the meta-structure. The order in which the method (200) is described is not intended to be construed as a limitation, and any number of the described method blocks can be combined in any order to implement the method.

At block (202), a meta-structure is setup. In one embodiment, the meta-structure (102) is setup, wherein the meta-structure comprises at least two or more levels, a set of carbon capture tanks (CCT), a set of vertical overflow pipes and a set of horizontal overflow pipes. The structural material for the meta structure is bamboo, and each level of the meta-structure (102) is configured to accommodate a pair of CCTs.

At block (204), a water level is maintained within each CCT. In an embodiment, the water level is maintained till a predefined height within each CCT. Further, laminar flow of water is also maintained within each CCT via the overflow pipes by using an electrical pump. Additionally, a predefined range of pH and Total Dissolved Solids (TDS) of the water are also maintained in order to provide a suitable growth medium for azolla. The ideal pH for azolla growth is between 5 and 6, although the method can be operated within a pH range of 4-10. The pH of the growth medium is a robust indicator of system health and is a reliable parameter for tuning of the growth medium. The optimal TDS value has been found to have an upper threshold of 4000 ppm, with no lower bounds. Depending on the TDS value of the source water, the fertilization intensity and frequency are set. As the azolla grows through the process of absorbing nutrients from the growing media, the TDS value steadily drops over time. In addition, if evaporative losses are substantial, the TDS value could increase on its own. The growth medium's TDS varies over time due to a combined influence of the two processes mentioned above.

At block (206), a fertilizer is prepared for the growth medium from ripe banana peels. In one embodiment, the optimal fertilizer for the growth medium is prepared using ripe banana peels as the sole input resource. Understanding both the azolla fern's capabilities and the chemical makeup of banana peels is necessary to comprehend the rationale for this selection. Through the endophytic cyanobacteria Anabaena azollae, which is found in the azolla fronds, Azolla pinnata is able to fix nitrogen from the atmosphere. With very little nitrogen, banana peels are a special kind of organic waste that decomposes naturally. Thus, the azolla fern growing in the CCT receives little to no nitrogen from a fertilizer solution generated from banana peels. The fern's special capacity to extract nitrogen from the surrounding air means that this is not a factor restricting its growth. However, due to the absence or limited amount of nitrogen in the growth medium, other competitors such as greater duckweed (Lemna major), lesser duckweed (Lemna minor) and algae are heavily suppressed.

In one embodiment, the fertilizer is prepared by submerging finely chopped banana peels in water in the ratio of 50 g (fresh weight) banana peels in 20 liters of water for every 1 m² of CCT area per week. The solution is left uncovered and stirred continuously by an aerator for a period of 48-60 hours, depending on the season of the year. The aerobic decomposition of the banana peels yields a phosphate rich fertilizer, which is ideal for sustained growth of the azolla fern. The resulting fertilizer solution has a pH of 5-5.5, which can be added to the CCT to regulate the growth medium pH for optimal azolla cultivation. Anaerobic decomposition is avoided due to the generation of NH₃, which has an overall effect of raising the pH of the fertilizer solution, which is detrimental to the operation of the azolla cultivation operation.

At block (208), sediment load including soil and biomass components is removed. Furthermore, due to the fern's nitrogen fixing ability, there is a significant possibility of high ammonia content in the growth medium. The soil acts as a buffer, preventing pH rise of the growth medium due to ammonia generation. In one embodiment, the sediment load (soil and biomass components) of each CCT is removed in every 6 months to prevent excessive nitrogen buildup in the growth medium. The removed sediment load can be used as fertilizer for reclaiming degraded landscapes or for facilitating agricultural activities on fertile lands, reducing dependence on synthetic chemical fertilizers.

At block (210), fertile soil that is acidic in nature is added to each CCT. In one embodiment, fertile soil, preferably acidic in nature, is added initially to each CCT at a rate of 1-1.5 kg/m². The soil performs two functions within the CCT. A small amount of soil is enough to provide one CCT with enough micro-nutrients for about 6 months of operation, while macro-nutrients are replenished regularly using the banana peel fertilizer.

At block (212), azolla inoculum is introduced in each CCT. In one embodiment, upon preparing the growth medium in each CCT, the azolla inoculum is introduced covering at least 75% of CCT area. There are two reasons for the same. Firstly, more than 25% exposed surface area of the CCT can catalyze algal growth, especially during the summer months. Algal growth causes the pH to rise during the day due to uptake of CO₂ from the growth medium and conversely contributes to pH reduction at night due to release of CO₂. The resulting pH swing is detrimental for azolla growth and should be attenuated as much as possible. Inoculating each CCT so that at least 75% of the surface area is covered by azolla significantly reduces the aforementioned risk. Secondly, a high amount of exposed surface area makes the CCT vulnerable to mosquito larvae infestations. While at maturity, the azolla mat prevents mosquitos from laying their eggs in the CCT, care must be taken during the initial inoculation phase to check such parasitic infestations.

The azolla fern has a low biomass doubling time of 2-5 days. However, after inoculation, the azolla fern requires an acclimatization period of 12-14 days before steady growth is initiated. The controlling unit-based water flow system ensures regular water movement between all CCTs of one or more meta-structures at regular intervals determined by the control instructions. The aerators agitate the water to release generated gases such as NH₃ and H₂S to maintain the pH of the growth medium within the optimal range of 5-6. The arrangement of sprinklers is responsible for maintaining relative humidity within the meta-structure micro-climate to desirable values of more than 75% as well as keeping the azolla fronds in dry climates or during summer months in humid climates. Manual agitation and de-clumping of azolla fronds is essential to ensure maximum growth rate of the azolla fern. Manual agitation is facilitated through a ‘bottom-up approach’, wherein a two-dimensional stirring device fitted with a handle is submerged in the growth medium and then pushed upwards till it just touches the underside of the azolla fronds. The stirring device is then moved laterally from side to side to loosen the azolla aggregates from time to time. Such technique ensures that the buoyancy of azolla fronds is maintained during the agitation process. If the azolla aggregate is pushed down during this process, there is a significant probability of azolla fronds getting intertwined and trapped within the azolla roots, leading to submerged and eventually dead azolla, which decomposes and increases the pH of the growth medium.

Further, two species of snails (ramshorn snails and golden apple snails) are the dominant pests which can potentially destroy the entire azolla culture within a CCT. To combat the threat of snail infestations, a passive technique of snail attraction and removal is employed. Cucumbers and ridge gourds are the only two ingredients required for this process. The ridge gourd and cucumber are cut transversely into discs of thickness 1 cm and 1.5 cm respectively. These dimensions ensure appropriate buoyancy of the snail attraction discs (SAD) such that the surface of each SAD is slightly elevated above the water surface. The SADs are placed at regular spatial intervals across the CCT surface area. Cucumber SADs are used for intra-day applications due to their short disintegration time. Ridge gourd SADs can be used and recycled across a period of 5 days. After SAD deployment in snail-infested CCTs, in 3-4 hours, the snails will dominantly cluster on/near the SADs, facilitating instantaneous removal from the infested CCTs. Such process can be iteratively replicated till the snail population has been significantly reduced. A distinctive feature of using cucumber and ridge-gourd based SADs is that they do not significantly alter the pH of the growth medium, which is a desirable quality vis-à-vis the long-term sustainability of operations.

At block (214), amassed azolla is periodically harvested from the CCT at a pre-defined frequency and intensity. In one embodiment, single-bedding (B1) is defined as the condition of the CCT wherein the azolla completely covers the CCT area without overlapping. Double bedding (B2) is defined as the state of the CCT wherein the azolla fronds have significant overlap with other fronds. The harvesting intensity and frequency is determined solely on the basis of the bedding stage of the CCT. The azolla is harvested at a stage between B1 and B2. Harvesting while the CCT is in the B1 state may lead to harvesting of immature azolla and/or exposing significant surface area of the CCT to diffuse solar radiation, increasing the risk of algal infestation. Delaying the harvest till the B2 state has the risk of slowing down overall azolla growth rate. The harvesting action is facilitated with sieve-like nets, aggregating the mature azolla biomass and preferentially sparing the relatively immature azolla fronds. Optimally, the harvest should be along the perimeter of each CCT, such that in the post-harvest state, it is possible to radially distribute the remaining central azolla aggregate to cover at least 75% of the CCT area, to reduce the risk of post-harvest algal infestation.

Therefore, the azolla cultivation can be significantly increased by following the aforementioned method including respective particulars parameters mentioned therein. As the Azolla growth increases, it creates higher-order impacts on the environment, wherein such impacts include but not limited to:
1) Level 0
   L01 Carbon captured by building material
   Bamboo is the fastest growing grass on Earth, with widespread applications as a sustainable building material due to its good structural properties. This makes bamboo the ideal material for facilitating the large scale vertically scaled cultivation of azolla. In contrast to alternative building materials that would otherwise emit greenhouse gases during the manufacturing process, bamboo offers carbon capture and sequestration opportunities even at the construction phase of the project.
   L02 Emissions avoided due to organic waste utilization
   No synthetic fertilizers are utilized to facilitate azolla growth. All nutrient requirements are met by streamlining channels of organic waste, preventing or at least reducing the quantum of greenhouse gases that would have otherwise been emitted at landfills.
2) Level 1
   L10 Carbon captured through biomass growth
   Owing to its low biomass doubling time, the rapidly growing azolla biomass captures atmospheric carbon dioxide through photosynthesis. The continuous cycle of growth, harvest and re-growth keeps capturing atmospheric carbon dioxide, while the endophytic cyanobacteria capture atmospheric nitrogen.
3) Level 2
   L21 Emissions avoided by offsetting the manufacture of synthetic fertilizers
   By utilizing the harvested azolla biomass as a bio-fertilizer, the demand for conventional synthetic fertilizers such as urea and di-ammonium phosphate will be reduced. In turn, the manufacturing emissions associated with the amount of offset fertilizer demand will be bypassed.
   L22 Emissions avoided in the post-application phase
   Nitrogenous fertilizers are not only quite emission-intensive products, but also having cascading emissions after their field application. The application of synthetic fertilizers produces other potent greenhouse gases like methane and nitrous oxide, which are respectively about 30 and 300 times more potent than carbon dioxide as a greenhouse gas.
4) Level 3
   L30 Increased carbon capture and storage capacity of reclaimed landscapes
   If the harvested biomass (either in composted form or as a bio-fertilizer) is utilized for soil amendment, land reclamation, fertility restoration or any other such activities, the modified landscape shall have increased carbon capture potential due to vegetation growth following azolla based bio-remediation.

Resulting GHG reduction=L01(CO₂)+L02(CO₂+CH₄)+L10(CO₂)+L21(CO₂)+L22(N₂O+CH₄)+L30(CO₂)

### Statistical Representations

### Representation 1: Carbon Captured Through Biomass Growth

The mathematical model of azolla biomass growth shows that azolla follows an initial exponential growth phase, followed by a linear growth phase when it approaches standing crop conditions.

yₜ=y₀^{RGR.t} (1)

yₜ=AGR.t+b (2)

where yₜ is the standing crop (g/m²), y₀ is the initial standing crop (g/m²), RGR is the relative growth rate (day⁻¹), AGR is the absolute growth rate (g/m²-day), b is the standing crop at the start of the linear growth and t is time (days). For Azolla pinnata, RGR was reported to be 0.317 d⁻¹ and AGR was reported to be 11.1 g/m²-day.

A modelling study used the above equations, assuming that the azolla would perennially remain in the exponential growth phase under optimal conditions to estimate that 1 hectare of such optimal azolla cultivation would sequester 78,046 kg of CO₂ annually, assuming 42% carbon content in dry azolla biomass. For this modelling exercise, yₜ=450 kg, t=2 days and RGR=0.5 d⁻¹. However, such optimal assumptions are seldom realized in actual operations. The process of calculation of captured CO₂ from the fresh weight of the harvested biomass is as follows:
1) Fresh weight of harvested azolla (FW): The azolla is harvested once double bedding condition is reached. The excess water is allowed to drain out and the fresh weight of the biomass is recorded.
2) Dry weight of azolla biomass (DW): Fresh weight samples are dried every week to obtain an average ratio of dry to fresh weight. For our study, the observed ratio is 0.07.

DW=0.07×FW (3)
3) Carbon content of biomass (CB): The carbon content of the dry biomass is estimated through ultimate analysis. The carbon content of azolla is fairly constant, regardless of species and growing conditions. For our study, we have assumed a carbon content of 42%, pending empirical tests on harvested azolla samples.

CB=0.42×DW (4)
4) Captured CO₂: The captured atmospheric CO₂ can be quantified by the stoichiometric relationship between atomic carbon and molecular carbon dioxide.

CC=3.67×CB (5)
The empirical equation thus becomes:

CC=0.107898×FW (6)

### Representation 2: Manufacturing Emissions Offset Through Utilization of Azolla Bio-Fertilizer

Further, manufacturing emissions can be reduced due to reduction in urea demand through utilization of azolla bio-fertilizer. 1 kg Urea is known to have 46% Nitrogen i.e. 460 g N/kg Urea. Nitrogen losses from urea could be as high as 42% through volatilization or leaching suggesting 193.2 g (i.e., 460 g×0.42=193.2 g) of Nitrogen loss resulting 266.8 g (i.e., 460 g−193.2 g=266.8 g) of usable nitrogen available for the plant.

The dry weight of Azolla mostly comprises of protein (23 to 27%), followed by nitrogen (3-6%), potassium (2-4.5%), phosphorus (0.5-0.9%) among other majors and micronutrients. Therefore, 1 kg of dry azolla will have about 30 g available nitrogen for plant utilization, making 8.89 kg (i.e., 266.8 g/30 g=8.89) of dry azolla equivalent to 1 kg urea in terms of nitrogen content.

Further, emission intensity of Urea is 4018.9 g CO₂e/kg N. Therefore, 1 kg urea manufacturing emissions is 1072.24 gCO₂e/kg urea (i.e., 4018.9×0.2668=1072.24). Thus, 1 kg urea is equivalent to 8.89 kg of dry azolla which in turn is equivalent to 127 kg fresh azolla in terms of nitrogen equivalence. Accordingly, it is derived that 1 kg fresh azolla displaces 8.44 gCO₂e (i.e., 1072.24/127=8.44).

Furthermore, for 1 m² of azolla cultivation leads to harvested fresh azolla biomass of 71.36 kg/m²-year and consequently the carbon captured through such biomass growth (L10) as 7.7 kgCO₂e/m²-year (i.e., 71.36×0.107898=7.7). Accordingly, reduction in Urea manufacturing emissions (L21) is 602.31 gCO₂e/m²-year (i.e., 71.36×8.44=602.31). Therefore, the effective emissions captured and offset (L10+L21) is 8.30 kgCO₂e/m²-year.

### Bio-Fertilizer Production

The harvested azolla biomass is placed in stages in cylindrical containers with drainage holes provided at the bottom. After each stage of biomass addition, Lactobacillus bacteria is used to inoculate the biomass for self-composting. The alternate layers of azolla biomass and Lactobacillus inoculum are stacked till 80% of the container volume is filled. The container is closed and left for 10 days. There is no requirement of agitation or mixing during this period. The anaerobic decomposition of the biomass yields an organically derived soil amendment bio-fertilizer.

### Land Reclamation

The resulting azo-compost can be veritably used to reclaim degraded, deforested or desertified landscapes. Applying the azo-compost as a mulching layer on barren landscapes prevents direct exposure of the topsoil to ultra-violet radiation from the solar electromagnetic spectrum, gradually regenerating the microbial diversity of the soil. Due to the water retention capability of the azo-compost, the mulched area also starts acting as a watershed, holding significantly higher amounts of water during periods of rainfall, reducing surface runoff and increasing water percolation, gradually recharging the local water-table and influencing local micro-climate in the medium to long term. Primary succession, secondary succession or artificial reforestation has the potential to convert these previously denuded landscapes into ‘green’ landscapes, imparting a certain degree of carbon capture and sequestration potential to these restored landscapes.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. While various aspects and embodiments have been disclosed herein, other aspects and embodiment will be apparent to those skilled in the art.

1) A system (100) for enabling artificial cultivation of azolla for enhancing sequestration of environmental CO₂, the system (100) comprises:
a) a meta-structure (102) having at least two or more levels, wherein structural material for the meta structure (102) is bamboo and the two or more levels are equidistantly placed across height of the meta-structure (102);
b) a set of carbon capture tanks (CCT) (104), wherein each level of the meta-structure (102) is configured to accommodate a pair of CCTs;
c) a set of vertical overflow pipes (106) and a set of horizontal overflow pipes (108);
d) a façade material to cover part of the meta-structure (102);
e) an electrical pump (150) for maintaining laminar water flow in each CCT via the overflow pipes;
f) a set of nozzle-based sprinklers (152) installed over CCTs for maintaining humidity requirement of azolla;
g) a set of temperature and humidity sensors (154) for sensing ambient temperature and humidity of the meta-structure (102);
h) a set of water temperature sensors (156) for sensing temperature of water flowing through the CCTs;
i) a set of pH sensors (158) for determining pH of the liquid medium;
j) a set of aerators (160) to provide regular mixing of growth medium;
k) a real time clock (162);
l) a set of fans (164) for regulating meta-structure temperature and humidity
m) a controlling unit (166) capable of modulating the electrical pump (150), the aerators (160), the sprinklers (152), and the fans (164), wherein the controlling unit (166) is communicably coupled with the temperature and humidity sensors (154), the water temperature sensors (156), the pH sensors (158), the real time clock (162);
n) a power source (168) for supplying power to the electrical pump (150), the aerators (160), the sprinklers (152), the temperature and humidity sensors (154), the water temperature sensors (156), the pH sensors (158), the real time clock (162), the fans (164) and the controlling unit (166),
characterized in that,
the controlling unit (166) is configured to automatically control operations of the pump (150), the aerators (160), the sprinklers (152), and the fans (164) based on received input from the temperature and humidity sensors (154), the water temperature sensors (156), the pH sensors (158), and the real time clock (162) so as to maintain desired micro-climate for growth of azolla.

2) The system (100) as claimed in claim 1, orientation of each of the pair of CCTs is transverse to the orientation of the meta-structure (102) i.e., the longer edge of the meta-structure (102) corresponds to the shorter edge of the CCTs, and the pair of CCTs on each level is separated by a inter CCT gap of 1.2-1.5 meters.

3) The system (100) as claimed in claim 1, wherein water level in each CCT is maintained at 0.15-0.20 meter for optimal growth of azolla.

4) The system (100) as claimed in claim 1, inter-level spacing of the two or more equidistantly placed levels is determined based on breadth of the meta-structure (102) and maximum value of zenith angle of the Sun in particular latitude of location of the meta-structure (102).

5) The system (100) as claimed in claim 1, wherein each level of the meta-structure (102) is mounted with a vertical overflow pipe (106) along an outer edge of a CCT of the pair of CCTs to transmit water from one level to the corresponding CCT on level immediately below and a horizontal overflow pipe (108) along an inner edge of both the pair of CCTs to connect both the pair of CCTs, wherein both the vertical overflow pipe (106) and the horizontal overflow pipe (108) are connected to respective CCT(s) at a height of 0.21 meter of the same CCT.

6) The system (100) as claimed in claim 1, wherein the system (100) further comprises a water flow initiator (WFI) pipe that connects one of the pair of CCTs at lowermost level to corresponding CCT on the topmost level, wherein an inlet is connected to the vertical overflow pipe of one of the CCTs at the lowermost level, forming the first part of the WFI, and a pump outlet transmits water from the lowermost CCT to the corresponding CCT on the topmost level.

7) The system (100) as claimed in claim 1, wherein area of the façade material is determined based on the latitude of the location of the meta-structure (102) so as to maintain an optimal micro-climate for azolla growth upon reducing evaporative losses and preventing direct exposure to incident solar radiation.

8) The system (100) as claimed in claim 1, wherein the controlling unit (166) is configured to determine current season of the location of the meta-structure (102) based on accurate local time as received from the real time clock (162), and control seasonal functioning of the pump (150), the aerators (160), the sprinklers (152), and the fans (164) based on respective climate zone as preset by an operator.

9) The system (100) as claimed in claim 1, wherein the controlling unit (166) is further configured to determine time of day based on the input from the real time clock (162) and temperature differential between water and air based on the input received from the temperature and humidity sensors (154), the water temperature sensors (156), wherein the controlling unit (166) automatically increase frequency of the pump operations via WFI pipe after sunset upon determining a temperature differential in any season beyond a threshold of 3 °C-5 °C together with air temperature outside to bring the water temperature closer to a desired range.

10) The system (100) as claimed in claim 1, wherein the electrical pump, the aerators, the sprinklers, the temperature and humidity sensors, the water temperature sensors, the pH sensors, the real time clock, and the controlling unit (166) are powered by DC bus.

11) The system (100) as claimed in claim 1, wherein the power source is an array of photovoltaic (PV) panels installed on top of the meta-structure (102).

12) The system (100) as claimed in claim 11, wherein output from the PV panels is fed to a maximum power point tracking (MPPT) charge controller that relays energy to the electrical DC loads as well as a battery for applications during non-availability of solar radiation.

13) The system (100) as claimed in claim 1, wherein the bamboo used for the meta-structure (102) is processed by submerging raw harvested bamboo in water and treating with boric acid, cashew oil, wood-shell oil and grounds seeds of the poganum plant (Pongamia pinnata).

14) The system (100) as claimed in claim 1, wherein each CCT is fabricated using chlorinated polyvinylchloride (cPVC) to ensure structural longevity on continued exposure to attenuated solar radiation, and coated with black color so as to minimize the amount of radiation absorbed and consequently transmitted within the growth medium.

15) A method (200) for artificially improving growth of azolla in a meta-structure for enhancing sequestration of environmental CO₂, the method (200) comprises the steps of:
setting up (202) a meta-structure (102) comprising at least two or more levels, a set of carbon capture tanks (CCT), a set of vertical overflow pipes and a set of horizontal overflow pipes wherein structural material for the meta structure is bamboo, and each level of the meta-structure (102) is configured to accommodate a pair of CCTs;
maintaining (204) a water level till a predefined height within each CCT, laminar flow of water within each CCT via the overflow pipes by using a electrical pump, a predefined range of pH and Total Dissolved Solids (TDS) of the water in order to provide a suitable growth medium for azolla;
preparing (206) a fertilizer for the growth medium from ripe banana peels that is a organic biodegradable waste containing negligible amount of nitrogen;
removing (208) sediment load including soil and biomass components in a periodic interval in order to maintain nitrogen in the growth medium;
adding (210) fertile soil that is acidic in nature to each CCT at a rate of 1-1.5 kg/m² for providing micro-nutrients to azolla;
upon preparing the growth medium in each CCT, introducing (212) azolla inoculum in each CCT covering at least 75% of CCT area;
maintaining flow of water within each CCT for preserving desired pH of the growth medium, and humidity of the meta-structure (102) via a set of sprinklers for a predefined acclimatization period;
manually agitating azolla fronds after the acclimatization period to aid in additional growth of azolla; and
harvesting (214) azolla at a pre-defined frequency and intensity.

16) The method (200) as claimed in claim 15, wherein harvesting the azolla at the pre-defined frequency and intensity is performed proportionately with observed bedding stages i.e., the azolla is harvested 2 days after the B2 stage is reached and the post-harvested CCT should be at B0.75 stage to facilitate rapid exponential growth of the residual biomass and maximum biomass growth across a temporal period, wherein B0.75 indicates a stage when 75% of water surface is covered with azolla and B2 indicates a stage when 100% of water surface is covered with all azolla overlapping and no water visibility.

17) The method (200) as claimed in claim 15, the method (200) further comprises the step of pest management of the growth medium by:
cutting ridge gourd and cucumber transversely into discs of thickness 1 cm and 1.5 cm respectively such that surface of each snail attraction disc (SAD) is slightly elevated above water surface;
placing the SADs at regular spatial intervals across the CCT surface area so that snails can cluster on/near the SADs, facilitating instantaneous removal from the infested CCTs;
iteratively replicate the step of placement of cut SAD till the snail population is significantly reduced.

18) The method (200) as claimed in claim 15, wherein the step of preparing the fertilizer for the growth medium from ripe banana peels comprises:
submerging finely chopped banana peels in water in the ratio of 50-75 g banana peels in 20 liters of water for every 1 m² of CCT area per week; and
leaving the solution uncovered and stirred continuously by an aerator for a period of 48-60 hours, depending on the season of the year for aerobic decomposition of the banana peels that yields a phosphate rich fertilizer;
wherein the resulting fertilizer solution has a pH of 5-5.5, which is added to the CCT to regulate the growth medium pH for azolla.

19) The method (200) as claimed in claim 15, wherein the step of manually agitating azolla fronds comprises:
submerging a two-dimensional stirring device fitted with a handle in the growth medium;
pushing the stirring device upwards till the stirring device touches underside of the azolla fronds; and
moving the stirring device laterally from side to side to loosen the azolla aggregates from time to time.
